(19) United States
(12) Patent Application Publication
(10) Pub. No.: US 2007/0201570 A1
(43) Pub. Date: Aug. 30, 2007

(54) OFDM signal receiving apparatus, method of receiving OFDM signal, and digitalized terrestrial broadcast receiving apparatus

(75) Inventor: Kunio Okada, Iruma-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/709,434

(22) Filed: Feb. 22, 2007

(30) Foreign Application Priority Data
Feb. 28, 2006 (JP) 2006-051632

(51) Int. Cl. H04K 1/10

(52) U.S. Cl. 375/260

(57) ABSTRACT

A signal receiving apparatus is provided with RF-AGC circuit 102 for amplifying a high frequency OFDM signal and converting the signal into an intermediate frequency OFDM signal, IF-AGC circuit 107 for amplifying the intermediate frequency OFDM signal, extracting circuit 211 for extracting SP signals regularly disposed in the intermediate frequency OFDM signal amplified by the IF-AGC circuit 107, average-value calculating circuit 212 for calculating an average value of amplitudes of 144 SP signals extracted by the extracting circuit 211, and DAC circuit 213 for generating a control signal based on the average value calculated by the average-value calculating circuit 212, wherein the generated control signal is fed back to IF-AGC circuit 107, thereby controlling gain of the circuit 107.

### CROSS-REFERENCE TO RELATED APPLICATIONS

This application is based on and claims the benefit of priority from the prior Japanese Patent Application No. 2006-51632, filed Feb. 28, 2006, the entire contents of which are incorporated herein by reference.

### BACKGROUND OF THE INVENTION

1. Field of the Invention

The present invention relates to an OFDM signal receiving apparatus for receiving an electro-magnetic wave subjected to OFDM modulation process, Method of receiving OFDM signal, and Digitalized terrestrial broadcast receiving apparatus.

2. Description of the Related Art

In digitalized terrestrial broadcast, OFDM (Orthogonal Frequency Division Multiplexing) modulation system is used, which multiplexes plural signals for transmitting and/or receiving broadcast signals. In OFDM modulation system, an interval including an effective symbol duration and guard interval is defined as a signal transmission unit for transmitting OFDM signal. The guard interval is provided at a broadcast station for the purpose of eliminating interference between symbols caused by delayed waves due to reflection in multiple propagation paths. The guard interval is a copy of a waveform in the last half period of the effective symbol duration. For image transmission, a frequency band of 6 MHz is divided into 13 segments, and one segment among 13 segments is used for mobile terminals such as cellular phones.

In the digitalized terrestrial broadcast, OFDM modulation method is used, and a frequency band of 300 MHz (from 470 MHz to 770 MHz) is divided into 49 channels (from Channel 13 to Channel 62), and these channels are assigned to digitalized terrestrial broadcast stations. FIG. 10 is a block diagram showing a circuit configuration of a conventional OFDM signal receiving apparatus. The circuit configuration of the conventional OFDM signal receiving apparatus will be described with reference to FIG. 10.

As shown in FIG. 10, the conventional OFDM signal receiving apparatus 1000 comprises a tuner section 700, demodulating section 800 and decoding section 900. Further, the tuner section 700 comprises an external antenna ANT, LNA (Low noise amplifier) circuit 10, RF-AGC (Radio-Frequency Automatic Gain Control) circuit 12, RF-BPF (Radio-Frequency Band Pass Filter) circuit 14, RF mixer 16, IF-BPF (Intermediate-Frequency Band Pass Filter) circuit 18, IF-AGC (Intermediate-Frequency Automatic Gain Control) circuit 20, IF mixer 22, and LPF (Low Pass Filter) circuit 24 and RF-AGC control circuit 25.

OFDM signal broadcasted from a broadcast station is received via the external antenna ANT and amplified by LNA circuit 10 at a predetermined gain. The amplified OFDM signal is further supplied to and amplified by RF-AGC circuit 12, the gain of which is controlled depending on a feedback control signal fed back from RF-AGC circuit 25. The control signal is generated by RF-AGC control circuit 25 based on a signal level of an output signal of RF-BPF circuit 14.

OFDM signal which falls within a frequency band corresponding to a broadcast channel of a broadcast station selected by a user, is extracted by RF-BPF circuit 14 from OFDM signals whose level is controlled by RF-AGC circuit 12. The extracted OFDM signal is converted into an intermediate frequency signal by RF mixer 16. Further, a signal falling within a frequency band of the selected broadcast station is extracted from the intermediate frequency signal by IF-BPF 18, and supplied to IF-AGC circuit 20 to be amplified under control of IF-AGC control signal fed back from the demodulating section 800. IF-AGC control signal will be described later. The signal amplified by IF-AFC circuit 20 is converted into a low frequency signal by IF mixer 22, and subjected to a filtering process by LPF circuit 24. Then, the low frequency signal is output to the demodulating section 800.

The demodulating section 800 comprises ADC (Analog Digital Converter) circuit 26, FFT (Fast Fourier Transform) circuit 28, transmission-line equalization circuit 30, demodulating circuit 32, error correction circuit 34, BPF circuit 36, and IF-AGC control circuit 38.

The analog signal output from the tuner section 700 is converted into a digital signal in an analog/digital converting process by ADC circuit 26, and subjected to Fast Fourier Transform process by FFT circuit 28. A digital signal falling within a frequency range corresponding to a channel of the broadcast station selected by a user is extracted from the digital signal output from ADC circuit 26 by BPF circuit 36, and supplied to IF-AGC control circuit 38. IF-AGC control circuit 38 generates an IF-AGC control signal based on the digital signal output from BPF circuit 36. The IF-AGC control signal is converted to an analog signal by DAC circuit (not shown), and fed back to IF-AGC circuit 20 in the tuner section 700.

The signal output from FFT circuit 28 is subjected to a waveform equalization process (amplitude equalization, phase equalization) by the transmission-line equalization circuit 30, demodulating process by the demodulating circuit 32, and error correction process by the error correction circuit 34. During a series of these processes, TS (Transport Stream) is extracted from the received OFDM signal. The extracted TS is demodulated by the demodulating circuit 900, and a video and audio signal of TV broadcast are output.

Various techniques for controlling gain of OFDM signal receiving apparatus are known. For example, OFDM signal receiving apparatus is disclosed in Japanese Non-examined Patent Publication No. 2002-77101, in which various effective symbol durations are switched, and meanwhile OFDM signal of a desired frequency band is extracted from received OFDM signal by a tuner 700, and the gain of the extracted OFDM signal is controlled depending on the switched effective symbol duration so as to have an appropriate signal level, and then the gain controlled OFDM signal is supplied to ADC circuit 26 in the demodulating section 800.

In the OFDM signal receiving apparatus 1000 described above, the gains of RF-AGC circuit 12 and IF-AGC circuit 20 are controlled based on the output signals of RF-BPF circuit 14 and BPF circuit 36, respectively. In general, RF-BPF circuit 14 is designed so as to have a filtering characteristic that allows OFDM signal of one broadcast station selected by the user to pass through the same circuit 14. More specifically, RF-BPF circuit 14 has a filtering characteristic that allows frequency components falling with in a frequency range of 8 MHz to pass through. OFDM signal of one broadcast station having frequency range of 5.6 MHz can be extracted using the filtering characteristic of FR-BPF circuit 14.

In the digitalized terrestrial broadcast, since only a narrow frequency band of 0.4, MHz is provided between OFDM signal frequency bands of the adjacent broadcast stations, OFDM signals falling in the lower and higher frequency bands can be extracted together with the selected OFMD signal due to an unstable filtering characteristic of RF-BPF circuit 14. For example, in the case that B broadcast station “B” is selected from among broadcast stations “A”, “B” and “C”, parts of OFDM signals of the adjacent broadcast stations “A” and “C” can be extracted by RF-BPF circuit 14. Accordingly, OFDM signal of the selected broadcast station “B” mixed with OFDM signals of the broadcast stations “A” and “C” is supplied to the demodulating section 800. As the result, the gain control of RF-AGC control circuit 25 in the tuner section 700 is affected not only by the signal level of the selected OFDM signal but also by the signal levels of the adjacent OFDM signals.

Another OFDM signal receiving apparatus and method for receiving OFDM signal are proposed, which eliminate effects of a signal level of a broadcast station other than the selected broadcast station, and appropriately controls gain of OFDM signal from the selected broadcast station. In the proposed OFDM signal receiving apparatus, a control signal to be supplied to RF-AGC circuit in the tuner section is generated not based on the original signal of a frequency band of approximately 8 MHz but based on a signal falling within a frequency band of 6 MHz, which corresponds to a frequency band including a channel band of the selected broadcast station and the guard band.

FIG. 11 is view showing a circuit configuration of the proposed OFDM signal receiving apparatus 1000. As shown in FIG. 11, OFDM signal receiving apparatus 1000 comprises a tuner section 700, demodulating section 800 and decoding section 900. The circuit configuration of the proposed OFDM signal receiving apparatus 1000 will be described briefly with reference to FIG. 10. In the proposed OFDM signal receiving apparatus 1000 shown in FIG. 11, like elements as those in FIG. 10 are designated by like reference numerals, and their description is omitted.

The tuner section 700 shown in FIG. 11 is not provided with RF-BPF control circuit 25 shown in FIG. 10. Meanwhile, the demodulating section 800 is provided with RF-AGC control circuit 38 and IF-AGC control circuit 40. A digital signal of a frequency band corresponding to a channel band of the selected broadcast station is extracted by BPF circuit 36 in the demodulating section 800, and supplied to RF-AGC control circuit 38 and IF-AGC control circuit 40. OFDM signal output from BPF circuit 36 has a frequency band of 6 MHz, which corresponds to a frequency band including a channel band of the selected broadcast station and a guard band between channel bands of the adjacent broadcast stations, and therefore, OFDM signal does not include OFDM signal from a broadcast station other than the selected broadcast station. RF-AGC control circuit 38 generates a control signal based on the selected OFDM signal output from BPF circuit 36 and feeds back the generated control signal to RF-AGC circuit 12 in the tuner section 700. Therefore, effect of OFDM signal of broadcast stations other than the selected broadcast station is eliminated, and an appropriate gain control is realized based on only OFDM signal of the selected broadcast station (refer to Japanese Non-examined Patent Publication No. 2005-229533).

However, when high level noises are applied to OFDM signal transmitted from a broadcast station or to the electro-magnetic wave of the digitalized terrestrial broadcast, an disadvantage is caused such that the control signal for controlling gain of the received signal is generated based on the high level noises. For example, in the case that OFDM signal of one segment is received on a train and is subjected to the Fast Fourier Transform by FFT circuit, when a noise is applied to one of 1 to 432 carriers in such OFDM signal of one segment, the noise increases the level of such carrier higher than the other carriers. As the result, a problem is caused that the control signal is generated based on the carrier whose level is increased by the noise.

### SUMMARY OF THE INVENTION

The present invention has been made to solve the problem or disadvantage described above, and has an object to provide OFDM signal receiving apparatus and a method of receiving OFDM signal, which can execute an appropriate gain control even though a received electro-magnetic wave is affected by a high level noise.

According to one aspect of the present invention, there is provided an OFDM signal receiving apparatus which comprises receiving means for receiving OFDM modulated electro-magnetic wave to obtain a high frequency OFDM signal, high frequency amplifying means for amplifying the high frequency OFDM signal obtained by the receiving means, frequency converting means for converting the high frequency OFDM signal amplified by the high frequency amplifying means into an intermediate frequency OFDM signal, intermediate frequency amplifying means for amplifying the intermediate frequency OFDM signal obtained by the frequency converting means, extracting means for extracting synchronizing signals regularly disposed in the intermediate frequency OFDM signal amplified by the intermediate frequency amplifying means, calculating means for calculating an average value of amplitudes of the predetermined number of synchronizing signals extracted by the extracting means, and control signal generating means for generating a control signal for controlling gain of at least one of the high frequency amplifying means and intermediate frequency amplifying means, based on the average value calculated by the calculating means.

According to another aspect of the invention, there is provided an OFDM signal receiving apparatus which comprises receiving means for receiving OFDM modulated electro-magnetic wave to obtain a high frequency OFDM signal, high frequency amplifying means for amplifying the high frequency OFDM signal obtained by the receiving means, frequency converting means for converting the high frequency OFDM signal amplified by the high frequency amplifying means into an intermediate frequency OFDM signal, intermediate frequency amplifying means for amplifying the intermediate frequency OFDM signal obtained by the frequency converting means, transforming means for executing Fast Fourier Transform process on the intermediate frequency OFDM signal amplified by the intermediate frequency amplifying means to transform the OFDM signal from the time region to the frequency region, calculating means for calculating an average value of an amplitude of OFDM signal transformed to the frequency region by the transforming means, and control signal generating means for generating a control signal for controlling gain of at least one of the high frequency amplifying means and intermediate frequency amplifying means, based on the average value calculated by the calculating means.

According to other aspect of the invention, there is provided a method of receiving OFDM signal, which comprises step A of receiving OFDM modulated electro-magnetic wave to obtain a high frequency OFDM signal, and amplifying the obtained high frequency OFDM signal by high frequency amplifying means, step B of converting the high frequency OFDM signal amplified in step A into an intermediate frequency OFDM signal, and amplifying the intermediate frequency OFDM signal by intermediate frequency amplifying means, step C of extracting synchronizing signals regularly disposed in the intermediate frequency OFDM signal amplified in step B, step D of calculating an average value of amplitudes of the predetermined number of synchronizing signals extracted in step C, and step E of generating a control signal for controlling gain of at least one of the high frequency amplifying means and intermediate frequency amplifying means, based on the average value calculated in step D.

According to yet another aspect of the invention, there is provided a method of receiving OFDM signal, which comprises step A of receiving OFDM modulated electro-magnetic wave to obtain a high frequency OFDM signal, and amplifying the high frequency OFDM signal by high frequency amplifying means, step B of converting the high frequency OFDM signal amplified in step A into an intermediate frequency OFDM signal, and amplifying the intermediate frequency OFDM signal by intermediate frequency amplifying means, step C of executing Fast Fourier Transform process on the intermediate frequency OFDM signal amplified in step B to transform the OFDM signal from the time region to the frequency region, step D of calculating an average value of an amplitude of OFDM signal transformed to the frequency region in step C, and step E of generating a control signal for controlling gain of at least one of the high frequency amplifying means and intermediate frequency amplifying means, based on the average value calculated in step D.

According to still another aspect of the invention, there is provided a digitalized terrestrial broadcast receiving apparatus which comprises receiving means for receiving a digitalized terrestrial broadcast electro-magnetic wave to obtain a high frequency signal, high frequency amplifying means for amplifying the high frequency signal obtained by the receiving means, frequency converting means for converting the high frequency signal amplified by the high frequency amplifying means into an intermediate frequency signal, intermediate frequency amplifying means for amplifying the intermediate frequency signal obtained by the frequency converting means, extracting means for extracting scattered pilot signals regularly disposed in the intermediate frequency signal amplified by the intermediate frequency amplifying means, calculating means for calculating an average value of amplitudes of the predetermined number of scattered pilot signals extracted by the extracting means, and control signal generating means for generating a control signal for controlling gain of at least one of the high frequency amplifying means and intermediate frequency amplifying means, based on the average value calculated by the calculating means.

According to still other aspect of the invention, there is provided a digitalized terrestrial broadcast receiving apparatus which comprises receiving means for receiving a digitalized terrestrial broadcast electro-magnetic wave to obtain a high frequency signal, high frequency amplifying means for amplifying the high frequency signal obtained by the receiving means, frequency converting means for converting the high frequency signal amplified by the high frequency amplifying means into an intermediate frequency signal, intermediate frequency amplifying means for amplifying the intermediate frequency signal obtained by the frequency converting means, transforming means for executing Fast Fourier Transform process on the intermediate frequency signal amplified by the intermediate frequency amplifying means to transform the signal from the time region to the frequency region, calculating means for calculating an average value of an amplitude of signal transformed to the frequency region by the transforming means, and control signal generating means for generating a control signal for controlling gain of at least one of the high frequency amplifying means and intermediate frequency amplifying means, based on the average value calculated by the calculating means.

### BRIEF DESCRIPTION OF THE DRAWINGS

FIG. 1 is a block diagram showing a circuit configuration of OFDM signal receiving apparatus according to the first embodiment of the present invention;

FIG. 2 is a view showing a disposal pattern of SP signals included in OFDM signal;

FIG. 3A is a view showing a relationship between a phase and amplitude of a sent reference SP signal;

FIG. 3B is a view showing a relationship between a phase and amplitude of a received SP signal;

FIG. 4 is a view showing a signal waveform whose gain is controlled based on a level of a noise included in SP signal of OFDM signal;

FIG. 5 is a view showing a signal waveform whose gain is controlled based on an average value of levels of SP signals of OFDM signal;

FIG. 6 is a block diagram showing a circuit configuration of OFDM signal receiving apparatus according to the second embodiment of the present invention;

FIG. 7 is a block diagram showing a circuit configuration of a signal level detecting circuit shown in FIG. 6;

FIG. 8 is a block diagram showing a part of a circuit configuration of the signal level detecting circuit shown in FIG. 6;

FIG. 9 is a block diagram showing a circuit configuration of OFDM signal receiving apparatus according to the third embodiment of the present invention;

FIG. 10 is a block diagram showing a circuit configuration of a conventional OFDM signal receiving apparatus; and

FIG. 11 is a block diagram showing a circuit configuration of other conventional OFDM signal receiving apparatus.

### DETAILED DESCRIPTION OF THE PREFERRED EMBODIMENTS

Now, the first, second and third embodiments of OFDM signal receiving apparatus and a method of receiving OFDM signal according to the present invention will be described in detail with reference to the accompanying drawings. Further, modified embodiments thereof will be described, too.

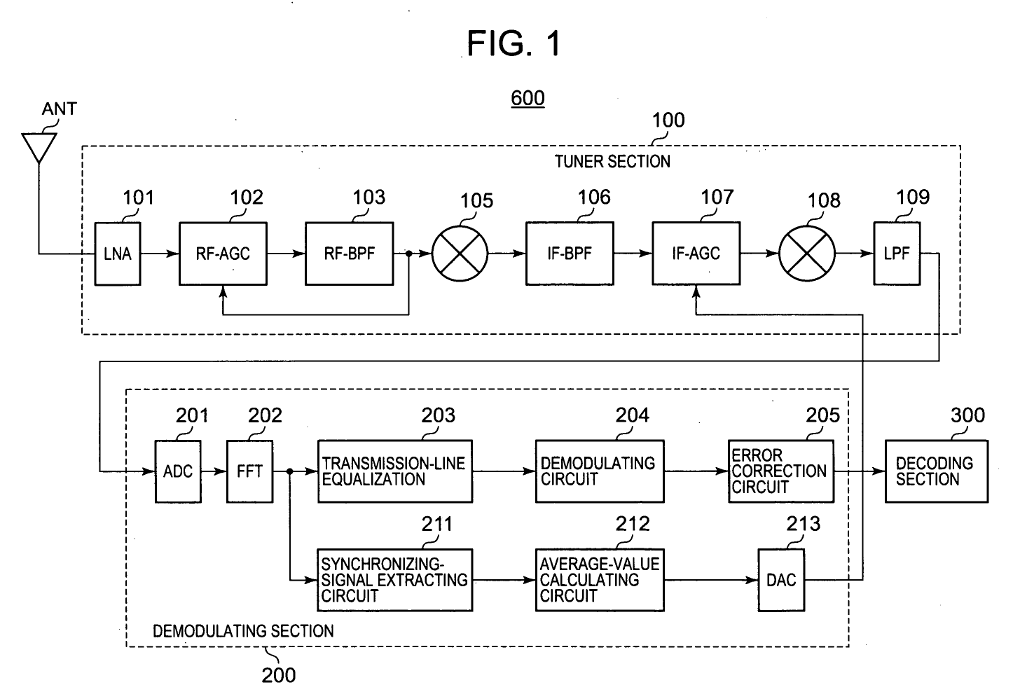

FIG. 1 is a block diagram showing a circuit configuration of OFDM signal receiving apparatus 600 according to the first embodiment of the invention. As shown in FIG. 1, OFDM signal receiving apparatus 600 comprises a tuner section 100, demodulating section 200 and decoding section 300. Further, the tuner section 100 comprises an external antenna ANT, LNA (Low noise amplifier) circuit 101, RF-AGC (Radio-Frequency Automatic Gain Control) circuit 102, RF-BPF (Radio-Frequency Band Pass Filter) circuit 103, RF mixer 105, IF-BPF (Intermediate-Frequency Band Pass Filter) circuit 106, IF-AGC (Intermediate-Frequency Automatic Gain Control) circuit 107, IF mixer 108, and LPF (Low Pass Filter) circuit 109.

OFDM signal broadcasted from a broadcast station is received via the external antenna ANT and amplified by LNA circuit 101 at a predetermined gain. The amplified OFDM signal is further supplied to and amplified by RF-AGC circuit 102, the gain of which is controlled depending on a control signal fed back from RF-PBF circuit 103. The control signal is generated by a feedback circuit (not shown) based on a signal level of an output signal of RF-BPF circuit 103.

OFDM signal which falls within a frequency band corresponding to a broadcast channel of a broadcast station selected by a user, is extracted by RF-BPF circuit 103 from OFDM signals whose level is controlled by RF-AGC circuit 102. The extracted OFDM signal is converted into an intermediate signal by RF mixer 105. Further, a signal falling within a frequency band of the selected broadcast station is extracted from the intermediate signal by IF-BPF 106, and supplied to IF-AGC circuit 107 to be amplified under control of IF-AGC control signal fed back from the demodulating section 200. IF-AGC control signal will be described later. The signal amplified by IF-AFC circuit 107 is converted into a low frequency signal by IF mixer 108, and subjected to a filtering process by LPF circuit 109. Then, the low frequency signal is output to the demodulating section 200.

The demodulating section 200 comprises ADC (Analog Digital Converter) circuit 201, FFT (Fast Fourier Transform) circuit 202, transmission-line equalization circuit 203, demodulating circuit 204, error correction circuit 205, synchronizing-signal extracting circuit 211, average-value calculating circuit 212, and DAC (Digital Analog Converter) circuit 213.

The analog signal output from the tuner section 100 is converted into a digital signal in an analog/digital process by ADC circuit 201, and subjected to Fast Fourier Transform process by FFT circuit 202. The signal output from FFT circuit 202 is subjected to a waveform equalization process (amplitude equalization, phase equalization) by the transmission-line equalization circuit 203, demodulating process by the demodulating circuit 204, and error correction process by the error correction circuit 205. During a series of these processes, TS (Transport Stream) is extracted from the received OFDM signal. The extracted TS is demodulated by the demodulating circuit 300, and a video and audio signal of TV broadcast are output.

Meanwhile, the digital signal output from FFT circuit 202 is supplied to the synchronizing-signal extracting circuit 211, where SP signals (Scattered Pilot signals), which are regularly disposed in the digital signal, are extracted. SP signal is a sort of synchronizing signal, employed in the standard terrestrial TV broadcast system, and is used in the waveform equalization process executed by the transmission-line equalization circuit 203. SP signals each have a predetermined phase and amplitude, and scattered in OFDM signal at a terrestrial digitalized broadcast station.

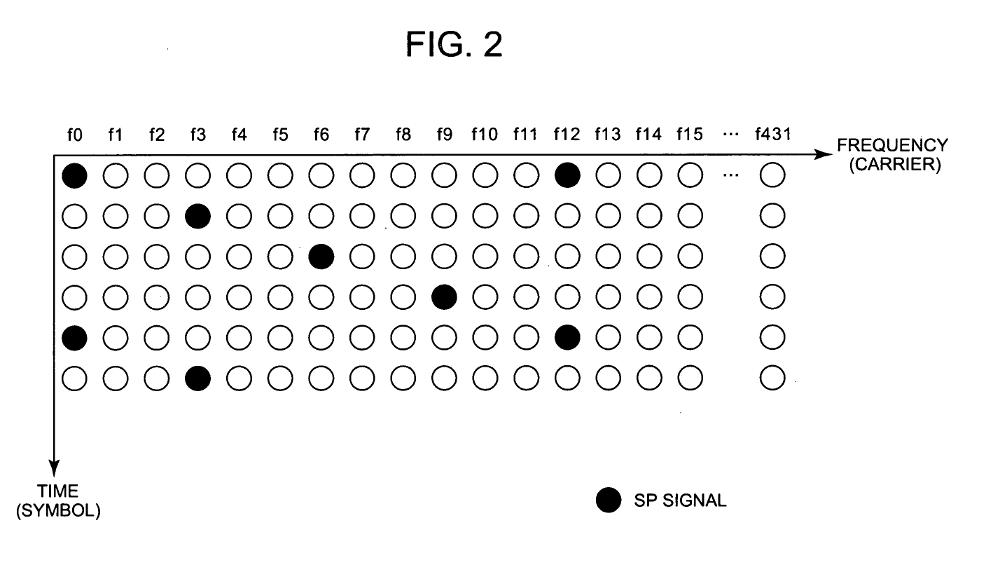

FIG. 2 is a view showing an example of disposal pattern of SP signals in symbols of OFDM signal. In FIG. 2, black circles represent SP signals and white circle represent data signal and the like other than PS signals. As shown in FIG. 2, SP signals are disposed every 12 carriers in 432 carriers included in one segment of OFDM signal. Further, the disposal of SP signals is determined so as to vary periodically. In FIG. 2, SP signals are shifted in disposal every three carriers in each symbol, and the disposal of SP signals returns to the original disposal every four symbols. In other words, SP signals are disposed such that four sorts of disposal patterns appear sequentially, and 144 (=4×36) SP signals are included in one cycle.

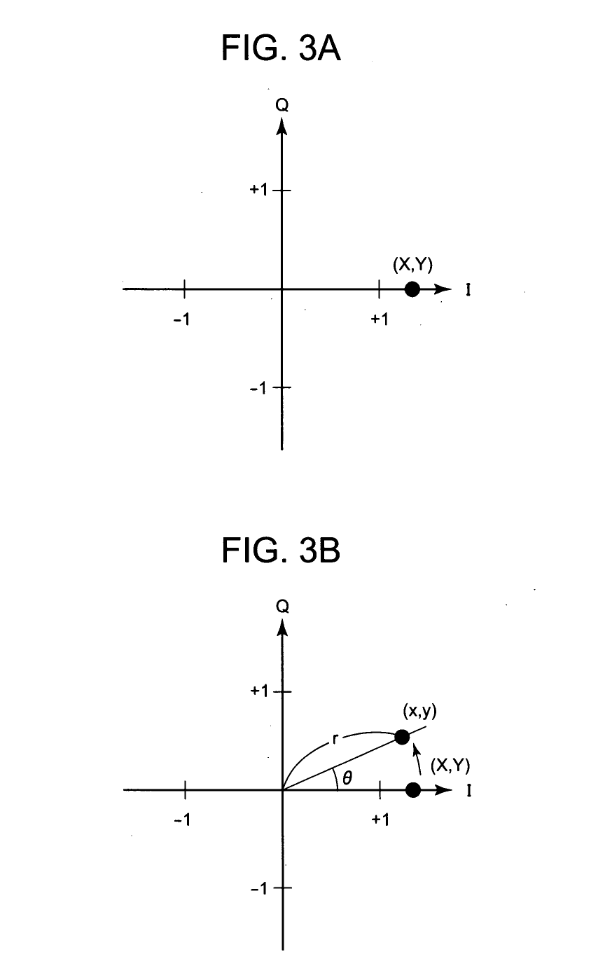

As shown in I-Q constellations of FIGS. 3A and 3B, SP signal changes in phase and amplitude depending on a state of the transmission line. FIG. 3A is I-Q constellation showing a signal point of the reference SP signal indicated, when BPSK (Bi-Phase Shifter Keying) signal is transmitted. FIG. 3B is I-Q constellation showing a signal point of a received SP signal (hereinafter, “SP signal”) indicated, when BPSK (Bi-Phase Shifter Keying) signal is received. As shown in I-Q constellation of FIG. 3B, under effects of reflection, multi-paths and the like in signal receiving environment, the signal point of SP signal changes its phase by θ from the reference SP signal shown in I-Q constellation of FIG. 3A. The transmission-line equalization circuit 203 executes SP-signal error calculating process to calculate a difference between SP signal included in data signal from FFT circuit 202 and a predetermined reference SP signal, thereby correcting phase and amplitude of the received data signal.

A level or amplitude “r” of an arbitrary SP signal extracted by the synchronizing-signal extracting circuit 211 is given by the following equation (1),

r=(I²+Q²)^{1/2} (1)

where “r” is a scalar value in the view shown in FIG. 3B. The synchronizing-signal extracting circuit 211 extracts a level of SP signal from data signal entered from FFT circuit 202, and supplies the level of SP signal to the average-value calculating circuit 212. The average-value calculating circuit 212 calculates an average of 144 SP signal levels supplied from the synchronizing-signal extracting circuit 211, using the following expression (2).

$$\frac{{\sum }_{n = 1}^{144} \sqrt{( {I}_{n}^{2} + {Q}_{n}^{2} )}}{144} \qquad ( 2 )$$

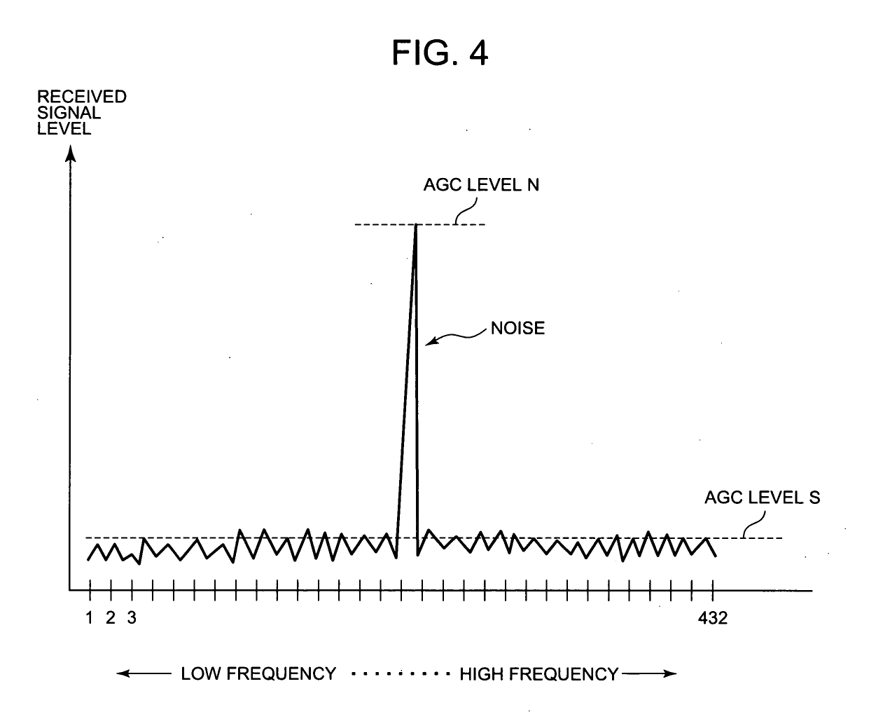

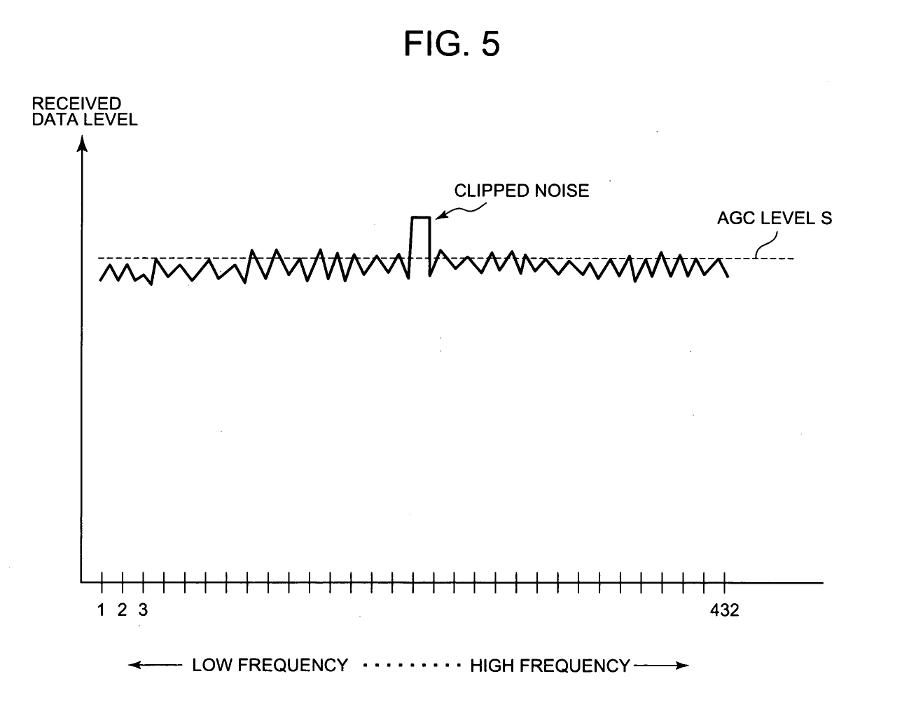

DAC circuit 213 converts the average value (digital signal) of 144 levels calculated by the average-value calculating circuit 212 into an analog signal, and feeds back the analog signal as an AGC control signal to IF-AGC circuit 107. FIG. 4 is a view showing SP signals which are fed back to the IF-AGC circuit 107 without calculating the average value thereof. In this case, AGC level N is decided, for example, depending on the peak level of the received electromagnetic wave including noises, and therefore a level of other SP signal including no noise is controlled or decreased by IF-AGC circuit 107 based on such AGC level N. Meanwhile, when an average value of levels of SP signals is calculated, a noise effect to the receiving signal level is reduced and AGC level S is set to a level which is lower than AGC level N. FIG. 5 is a view showing data level output from IF-AGC circuit 107, when AGC level S shown in FIG. 4 is fed back as AGC control signal to IF-AGC circuit 107. In this case, AGC level S, from which noise effect to be applied to the signal receiving level is reduced, is supplied to IF-AGC circuit 107, and IF-AGC circuit amplifies the signal to appropriate level, in which signal a noise of a large level is clipped off.

As described above, OFDM signal receiving apparatus according to the first embodiment of the invention comprises RF-AGC circuit 102, IF-AGC circuit 107, synchronizing-signal extracting circuit 211, average-value calculating circuit 212, and DAC circuit 213. RF-AGC circuit 102 amplifies the high frequency OFDM signal obtained from the received OFDM modulated electro-magnetic wave. IF-AGC circuit 107 amplifies the intermediate frequency OFDM signal which is obtained by frequency-converting OFDM signal amplified by RF-AGC circuit 102. The synchronizing-signal extracting circuit 211 extracts SP signals regularly disposed in OFDM signal amplified by IF-AGC circuit 107. The average-value calculating circuit 212 calculates the average of levels of 144 SP signals extracted by the synchronizing-signal extracting circuit 211. DAC circuit 213 generates and supplies the control signal to IF-AGC circuit 107, thereby controlling the gain of IF-AGC circuit 107.

Therefore, even though the received electro-magnetic wave includes a noise of large amplitude, the gain of IF-AGC circuit 107 is appropriately controlled by a control signal generated based on the average of SP signal levels obtained from 432 carriers in four symbols.

Now, OFDM signal receiving apparatus according to the second embodiment of the invention will be described.

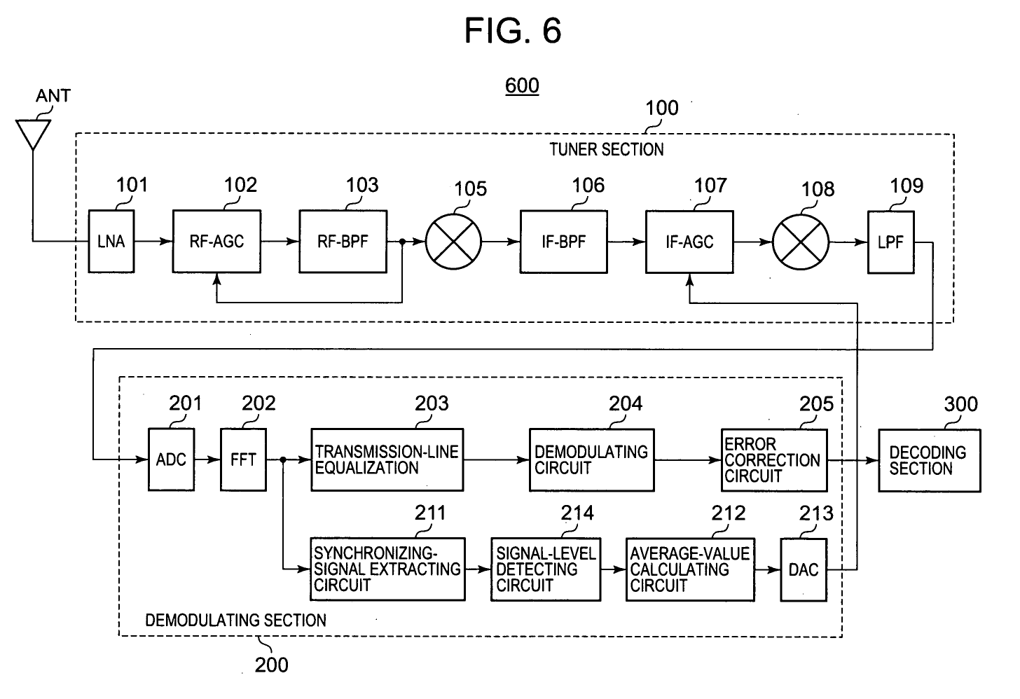

FIG. 6 is a block diagram showing a circuit configuration of OFDM signal receiving apparatus 600 according to the second embodiment of the invention.

As shown in FIG. 6, OFDM signal receiving apparatus 600 of the second embodiment comprises a tuner section 100, demodulating section 200 and decoding section 300. The tuner section 100 and decoding section 300 have the same configurations as those of the first embodiment. The demodulating section 200 has a substantially similar configuration to that of the first embodiment. Therefore, only different configuration of the second embodiment from the first embodiment will be described, and further description of the same configuration of the second embodiment as the first embodiment will be omitted.

In the OFDM signal receiving apparatus 600 shown in FIG. 6, there is provided a signal-level detecting circuit 214 between the synchronizing-signal extracting circuit 211 and average-value calculating circuit 212 in the demodulating circuit 200. The signal-level detecting circuit 214 determines that noises are included in n (integer equivalent to or larger than “1”) SP signal levels (from the first highest level to n-th highest level of SP signals) out of 144 SP signal levels extracted by the synchronizing-signal extracting circuit 211, and deletes these SP signal levels, and selects and supplies the remaining (144−n) SP signal levels to the average-value calculating circuit 212.

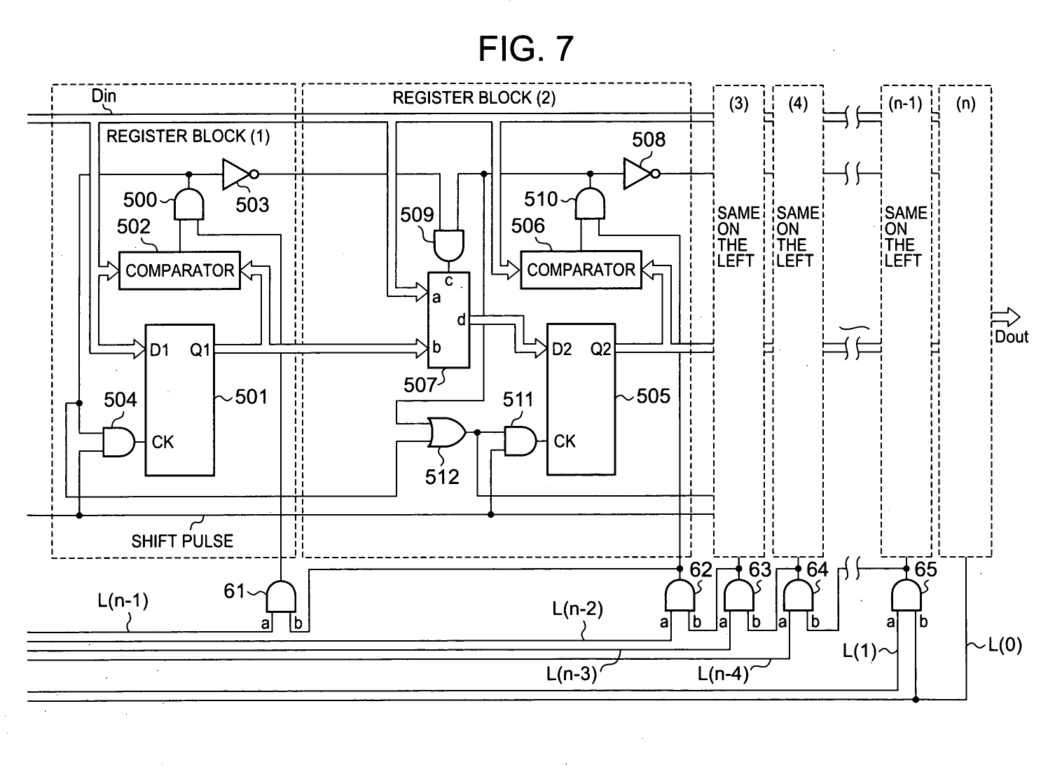

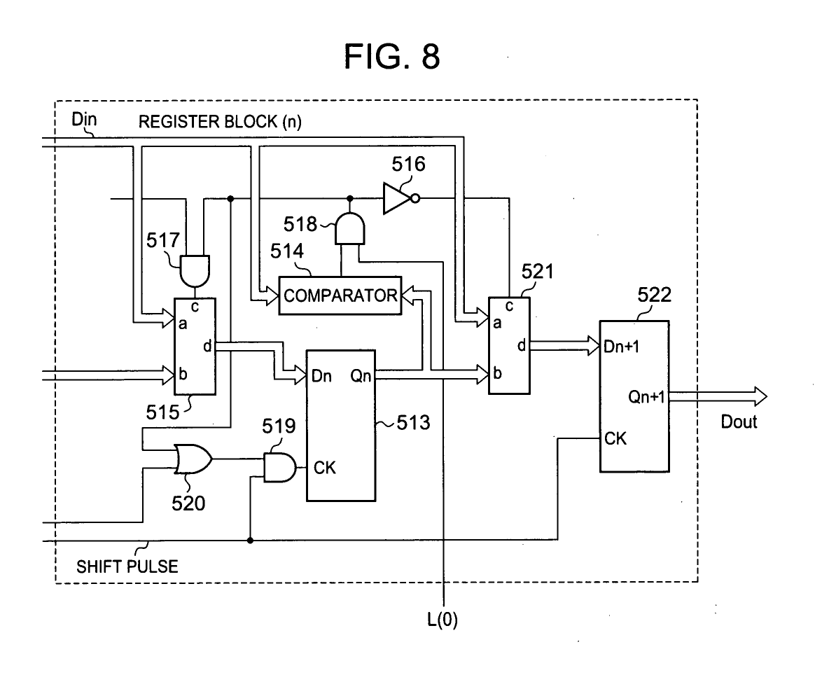

FIGS. 7 and 8 are views showing an example of a circuit configuration of the signal-level detecting circuit 214. The circuit configuration of the signal-level detecting circuit 214 is not limited to that shown in FIGS. 7 and 8, but various circuit configurations may be employed for the signal-level detecting circuit 214. Further, in place of the hardware, software may be used for realizing the similar functions to the signal-level detecting circuit 214. In either case, any configuration can be used, which can delete the top n-th SP signal levels from the 144 SP signal levels.

As shown in FIG. 7, the signal-level detecting circuit 214 comprises n units of register block circuits 50 and (n−1) units of AND circuits (AND circuits 61 to 65 consist a part of the (n−1) units of AND circuits). The register blocks (3) to (n−1) have the same internal circuit as the register block (2), and therefore description thereof will be omitted. FIG. 8 is a view showing the internal circuit of the register block (n).

As shown in FIG. 7, the register block (1) comprises a shift register 501, comparator circuit 502, inverter circuit 503 and AND circuits 504, 505. Upon receipt of a shift pulse signal from a timing generator (not shown) at CK terminal, the shift register circuit 501 receives SP signal level (hereinafter, “level Din”) from the synchronizing-signal extracting circuit 211 at its D1 terminal, and stores the level Din therein. The stored level Din is output from its Q1 terminal as level Q1. The level Q1 is stored and maintained until a new level Din is received at its D1 terminal. The shift pulse signal entered to CK terminal changes when the level Din has been confirmed.

The comparator circuit 502 compares the level Din with the level Q1 stored in the shift register circuit 501. When the level Din is larger than the level Q1, the comparator circuit 502 outputs a comparison signal of a high level. When the level Din is equivalent to or lower than the level Q1, the comparator circuit 502 outputs a comparison signal of a low level. AND circuit 500 supplies a signal of a high level or a signal of a low level to the inverter circuit 503 and AND circuit 504 in accordance with a logical product of an output of the comparator circuit 502 and an output of AND circuit 61.

Meanwhile, the register block (2) comprises a shift register 505, comparator circuit 506, selection circuit 507, inverter circuit 508, AND circuits 509, 510, 511, and OR circuit 512. Upon receipt of the shift pulse signal at its CK terminal, the shift register circuit 505 receives from D2 terminal and stores therein either level Din or level Q1, which is selected by the selection circuit 507. At this time, the shift pulse signal entered to CK terminal changes when the level Din has been confirmed. The shift register 505 outputs the stored level from its Q2 terminal as level Q2. (The level Q2 is stored and maintained until a new level is received at D2 terminal.) The comparator circuit 506 compares the level Din with the level Q2 stored in the shift register circuit 505. When the level Din is larger than the level Q2, the comparator circuit 506 outputs a comparison signal of a high level. When the level Din is equivalent to or lower than the level Q2, the comparator circuit 502 outputs a comparison signal of a low level. AND circuit 510 supplies a signal of a high level or a signal of a low level to the inverter circuit 508, AND circuit 509 and OR circuit 512 in accordance with a logical product of an output of the comparator circuit 506 and an output of AND circuit 62. An output of the inverter circuit 503 in the register block (1) at the previous stage is input to AND circuit 509. AND circuit 509 inputs the logical product of the output of AND circuit 510 and the output of the inverter circuit 503 to a control terminal “c” of the selection circuit 507. When a signal received at the control terminal “c” is of a high level, the selection circuit 507 selects the level Din at its input terminal “a”, and supplies the same level from its output terminal “d” to the shift register circuit 505. When the signal received at the control terminal “c” is of a low level, the selection circuit 507 selects the level Q1 at its input terminal “b”, and supplies the same level from its output terminal “d” to the shift register circuit 505. OR circuit 512 supplies to AND circuit 511 a logical sum of the signal from AND circuit 510 and the signal from AND circuit 500 in the register block (1) at the previous stage. When the signal received from OR circuit 512 is of a high level, AND circuit 511 makes the shift pulse signal received at CK terminal effective. On the contrary, when the signal received from OR circuit 512 is of a low level, AND circuit 511 makes the shift pulse signal received at CK terminal ineffective. Accordingly, when the shift pulse signal of the register block (1) is made effective, the shift pulse signal of the register block (2) is made effective, too.

The signal output from the inverter circuit 508 is supplied to AND circuit in the register block (3) at the following stage. This AND circuit corresponds to AND circuit 509 in the register block (2). The signal output from OR circuit 512 is supplied to OR circuit in the register block (3) at the following stage. This OR circuit corresponds to OR circuit 512 in the register block (2). Accordingly, when the shift pulse signal of the register block (2) is effective, the shift pulse signal of the register block (3) is made effective, too. The register blocks (4) to (n) operate in a similar manner. In other words, a shift pulse signal of an arbitrary register block in the signal-level detecting circuit 214 is made effective, the shift pulse signal of the following register block is made effective, too.

As shown in FIG. 8, the register block (n) comprises a shift register circuit 513, comparator circuit 514, selection circuit 515, inverter circuit 516, AND circuits 517, 518 and 519, OR circuit 520, selection circuit 521 and shift register circuit 522. Upon receipt of the shift pulse signal at its CK terminal, the shift register circuit 513 receives from Dn terminal and stores therein either level Din or level Qn−1 of the shift register in the register block (n−1) at the previous stage, which is selected by the selection circuit 515. At this time, the shift pulse signal entered to CK terminal changes when the level Din has been fixed.

The comparator circuit 514 compares the level Din with the level Qn stored in the shift register circuit 513. When the level Din is larger than the level Qn, the comparator circuit 506 outputs a comparison signal of a high level. When the level Din is equivalent to or lower than the level Qn, the comparator circuit 502 outputs a comparison signal of a low level. AND circuit 518 supplies a logical product of an output of the comparator circuit 514 and a signal input from a control line L(0) to the inverter circuit 516, AND circuit 517 and OR circuit 520.

An output of the inverter circuit in the register block (n−1) at the previous stage is input to AND circuit 517. AND circuit 517 inputs the logical product of the output of AND circuit 518 and the output of the inverter circuit in the register block (n−1) at the previous stage to a control terminal “c” of the selection circuit 515. When a signal received at the control terminal “c” is of a high level, the selection circuit 515 selects the level Din at its input terminal “a”, and supplies the same level from its output terminal “d” to the shift register circuit 513. When the signal received at the control terminal “c” is of a low level, the selection circuit 515 selects the level Qₙ₋₁ which is stored in the shift register circuit in the register block (n−1) and supplied to the input terminal “b”, and supplies the same level from its output terminal “d” to the shift register circuit 513.

Receiving a signal of a high level from AND circuit 518, the inverter circuit 516 supplies a signal of a low level to a control terminal “c” of the selection circuit 521. Meanwhile, receiving a signal of a low level from AND circuit 518, the inverter circuit 516 supplies a signal of a high level to the control terminal “c” of the selection circuit 521. When a signal received at the control terminal “c” is of a high level, the selection circuit 521 selects the level Din at its input terminal “a”, and supplies the same level from its output terminal “d” to the shift register circuit 522. When the signal received at the control terminal “c” is of a low level, the selection circuit 521 selects the level Qn at the input terminal “b”, and supplies the same level from its output terminal “d” to the shift register circuit 522.

Depending on the shift pulse signal, the shift register circuit 522 outputs the level Din or level Qn supplied from the output terminal “d” of the selection circuit 521 to the average-value calculating circuit 212 shown in FIG. 6. OR circuit 520 supplies to AND circuit 519 a logical sum of the signal from AND circuit 518 and the signal from OR circuit in the register block (n−1) at the previous stage. When the signal received from OR circuit 520 is of a high level, AND circuit 519 makes the shift pulse signal received at CK terminal effective. On the contrary, when the signal received from OR circuit 520 is of a low level, AND circuit 519 makes the shift pulse signal received at CK terminal ineffective. Accordingly, when the shift pulse signal of the register block (n−1) is made effective, the shift pulse signal of the register block (n) is made effective, too.

As shown in FIG. 7, outputs of AND circuits 61, 62, 63, 64 and 65 are connected to register blocks (1), (2), (3), (4) and (n−1), respectively. Although not shown in FIG. 7, omitted register blocks (5) to (n−1) are connected with outputs of AND circuits, respectively. The input terminals “a” of AND circuits 61, 62, 63, 64 and 65 are connected to the control lines L(n−1), L(n−2), L(n−3), L(n−4) and L (1), respectively, to control the signal-level detecting circuit 214.

Inputs of AND circuits whose outputs are connected to other register blocks (not shown) are connected to appropriate control lines. Further, an input “b” of AND circuit 61 is connected to an output of AND circuit 62, an input “b” of AND circuit 21 is connected to an output of AND circuit 63, and an input “b” of AND circuit 63 is connected to an output of AND circuit 64.

Inputs of AND circuits whose outputs connected to other register blocks (5) to (n−2) (not shown) are connected to outputs of AND circuits connected to register blocks (6) to (n−1). Accordingly, the output of AND circuit 65 connected to the register block (n−1) is connected to the input “b” of AND circuit connected to the register block (n−2) at the previous stage. But only the control line L(0) is connected directly to the register block (n), that is, the control line (0) is connected to AND circuit 518 in FIG. 8 and also connected to the input “b” of AND circuit 65 connected to the register block (n−1) at the previous stage. A signal of a low level is input to the control lines L(0) to L(n−1), but when the signal of a low level is not input to them, a signal of high level is input to appropriate AND circuits by means of a pull-up register (not shown).

Now, operation of the signal-level detecting circuit 214 will be described with reference to FIGS. 7 and 8. A signal of a low level is not input to the control lines L(0) to L(n−1), and all these control lines are kept at a high level. Accordingly, the outputs AND circuits connected to the register blocks (1) to (n−1) are kept at a high level. In this case, a signal of a high level is input to AND circuit 500 of the register block (1), and the comparison signal of the comparator circuit 502 is directly input to the inverter circuit 503, AND circuit 504 and OR circuit 512 in the register block (2). Similarly, a signal of a high level is input to AND circuit 510 in the register block (2), and the comparison signal of the comparator circuit 506 is directly input to the inverter circuit 508, AND circuit 509 and OR circuit 512 in the register block (2). In the register blocks (3) to (n−1) is performed similar operation to the register block (2).

In the register block (n) shown in FIG. 8, a signal of a high level is input to AND circuit 518, and the comparison signal of the comparator circuit 514 is directly input to the inverter circuit 516, AND circuit 517 and OR circuit 520. That is, when a signal of a low level is not input to all the control lines L(0) to L(n−1), a logical product of a signal output from the comparator circuit in the appropriate register block and a reversed signal output from the comparator circuit in the previous register block is input to the control terminal “c” of the selection circuit in each of the control lines L(0) to L(n−1).

The shift register circuit in each register block is reset to “0”, when the power is turned on, and further is reset to “0” before the first SP signal in the following 4 symbols is input after 144^{th} SP signal in the current symbol has been input. Accordingly, the initial value of level Q of each shift register and the first value in each 4-symbol period are reset to “0”.

Since the level Din of the first SP signal is larger than the level Q1 of the shift register circuit 501 in the register block (1), a signal of a high level is input from the comparator circuit 502 to the inverter circuit 503 and AND circuit 504. As the result, the shift pulse signal to the shift register circuit 501 is made effective, and the level Din is stored as the level Q1 in the shift register circuit 501.

When the level Din of the second SP signal is input, the comparator circuit 502 compares the level Din with the level Q1. When the level Din is equivalent to or lower than the level Q1, a signal of a low level is input from the comparator circuit 502 to the inverter circuit 503 and AND circuit 504 through AND circuit 500. As the result, the shift pulse signal to the shift register circuit 501 is made ineffective, and the level Din is not stored in the shift register circuit 501. Since the comparator circuit 506 in the register block (2) compares the level Din with the level Q2 (=0), a signal of a high level is input to the inverter circuit 508 and AND circuit 509. As the result, OR circuit 512 makes the shift pulse signal to the shift register circuit 505 effective, the level Din is stored in the shift register circuit 505.

Meanwhile, when the level Din is higher than the level Q1, a signal of a high level is input from the comparator circuit 502 to the inverter circuit 503 and AND circuit 504 through AND circuit 500. As the result, the shift pulse signal to the shift register circuit 501 is made effective, and the level Din is stored in the shift register circuit 501 as level Q1. Further, a signal of a low level is input from the inverter circuit 503 to AND circuit 509 in the register block (2). Accordingly, a signal level at the control terminal “c” of the selection circuit 507 becomes low, and level Q1 at the input terminal “b” is input from the output terminal “d” to D2 terminal of the shift register circuit 505. In this case, the shift pulse signal to the shift register circuit 505 is made effective through OR circuit 512, and the level Q1 is stored in the shift register circuit 505 as level Q2.

When level Din of the third and following SP signals is successively input and the level Din is higher than level Q1, level Q1 is used in place of the level Din and level Q2 is used in place of the level Q1. Meanwhile, when the level Din is equivalent to or lower than the level Q1 and higher than the level Q2, the level Q1 keeps the level stored upon receipt of the previous shift pulse signal and the level Q2 is used in place of the level Din and the level Q2 is stored in the shift register circuit in the register block (3) as level Q3. When the level Din is equivalent to or lower than the level Q1 and level Q2, the level Din is stored in the shift register circuit in the register block (3) as level Q3.

As described above, the highest level Din among 144 SP signals is stored in the register block (1), the second highest level Din is stored in the register block (2), the third highest level Din is stored in the register block (3), and n-th highest level Din is stored in the register block (n). And (n+1)-th highest level Din and the level Din which is lower than (n+1)-th highest level Din are not stored in any of register blocks are supplied to the average-value calculating circuit 212 shown in FIG. 6 through the selection circuit 521 and the shift register circuit 522 shown in FIG. 8. Meanwhile, when the level Din is stored in either register block, the level previously stored in the shift register circuit in the same register block is successively stored in the shift register circuit in the register block at the following stage. The level Qn stored in the shift register circuit 513 at the last register block (n) is input to the average-value calculating circuit 212 shown in FIG. 6 through the selection circuit 521 and shift register circuit 522.

In OFDM signal receiving apparatus according to the second embodiment of the invention, the signal-level detecting circuit 214 deletes the first highest level to n-th highest level of SP signals from among 144 SP signals input from the synchronizing-signal extracting circuit 211, and the average value calculating apparatus 212 calculates an average value of levels of the remaining (144−n) SP signals, and receiving the average value from the average value calculating apparatus 212 as the control signal, IF-AGC circuit 107 amplifies the intermediate frequency OFDM signal. Therefore, effects of noises included in SP signals, which will affect a level control of the intermediate frequency OFDM signal, can be minimized.

When a signal of a low level is not input to the control lines L(0) to L(n−1), the first highest level to n-th highest level SP signals are eliminated by the signal-level detecting circuit 214, but when a signal of a low level is input to either of the control lines, the number of the high level SG signals changes, which are to be eliminated by the signal-level detecting circuit 214. For example, when a signal of a low level is input to the control line L(n−1), the low level signal is transferred to AND circuit 500 in the register block (1) through AND circuit 61 as shown in FIG. 7. Accordingly, the low level signal is supplied from AND circuit 500 to the inverter circuit 503, AND circuit 504, and OR circuit 512 in the register block (2). As the result, the shift pulse signal to the shift register circuit 501 is made ineffective.

Meanwhile, when a high level signal is input from the inverter circuit 503 to the AND circuit 509 in the register block (2), the signal-level detecting circuit 214 eliminates the first highest level to (n−1)-th highest level SP signals from 144 SP signals in the register blocks (2) to (n), and the average-value calculating circuit 212 calculates an average value of levels of the remaining (144−n+1) SP signals.

When a low level signal is not input to the control line L(n−2) in FIG. 2, a low level signal is input to AND circuit 510 in the register block (2) through AND circuit 62. Accordingly, independently of a level of the comparison signal output from the comparator circuit 506, a low level signal is input to the inverter circuit 508, AND circuit 509 and OR circuit 512 through AND circuit 510. Further, in this case, since a low level signal is input from the output of AND circuit 62 to AND circuit 61, a low level signal is input to AND circuit 500 in the register block (1). As the result, the shift pulse signal to the shift registers 501 and 505 is made ineffective. In this case, the first highest level to (n−2)-th highest level of SP signals among 144 SP signals are eliminated in the register blocks (3) to (n) of the signal-level detecting circuit 214, and an average value of signal levels of the remaining (144−n+2) SP signals is calculated by the average-value calculating circuit 212.

Similarly, when the control signal of a low level is input to the control line L(n−3), the first highest level to (n−3)-th highest level of SP signals among 144 SP signals are eliminated in the register blocks (4) to (n) of the signal-level detecting circuit 214, and an average value of signal levels of the remaining (144−n+3) SP signals is calculated by the average-value calculating circuit 212. Further, when the control signal of a low level is input to the control line L(n−4), the first highest level to (n−4)-th highest level of SP signals among 144 SP signals are eliminated in the register blocks (5) to (n) of the signal-level detecting circuit 214, and an average value of signal levels of the remaining (144−n+4) SP signals is calculated by the average-value calculating circuit 212.

Therefore, depending on the control line to which a low level signal is input, ‘the signal-level’ detecting circuit 214 determines the number of SP signals of high levels to be eliminated. When a low level signal is input to the control line L(0), 144 SP signals input to the signal-level detecting circuit 214 is not eliminated, and the average-value calculating circuit 212 calculates an average value of levels of all the 144 SP signals. In this case, the second embodiment operates in a similar manner to the first embodiment.

Now, OFDM signal receiving apparatus according to the third embodiment of the invention will be described.

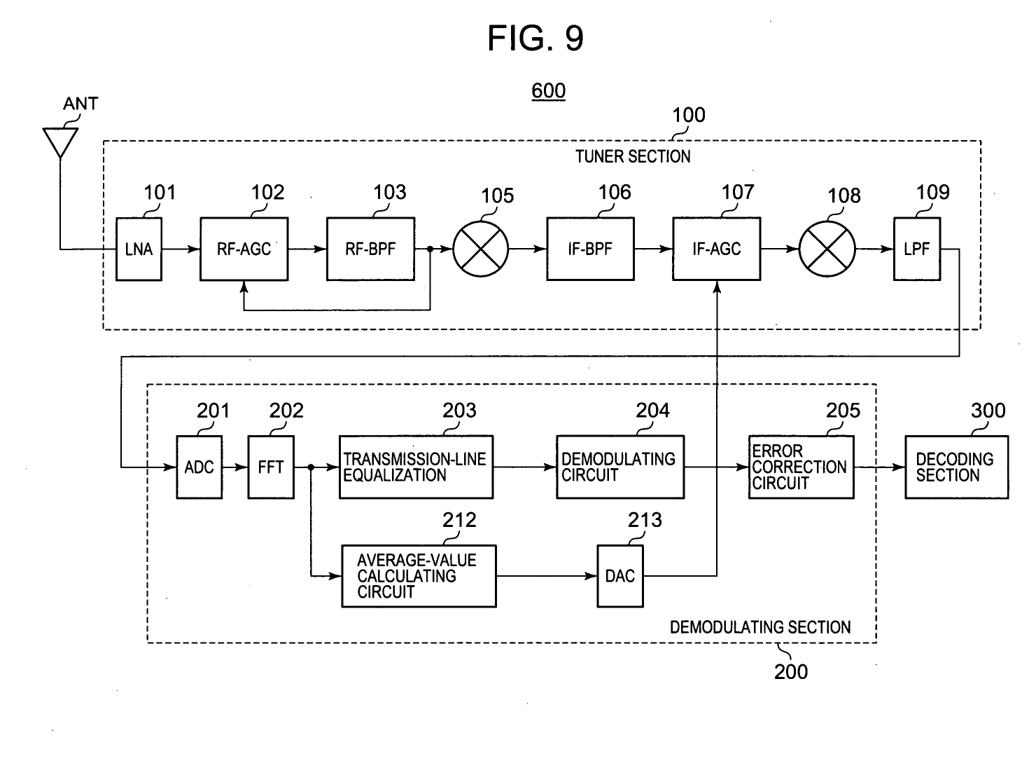

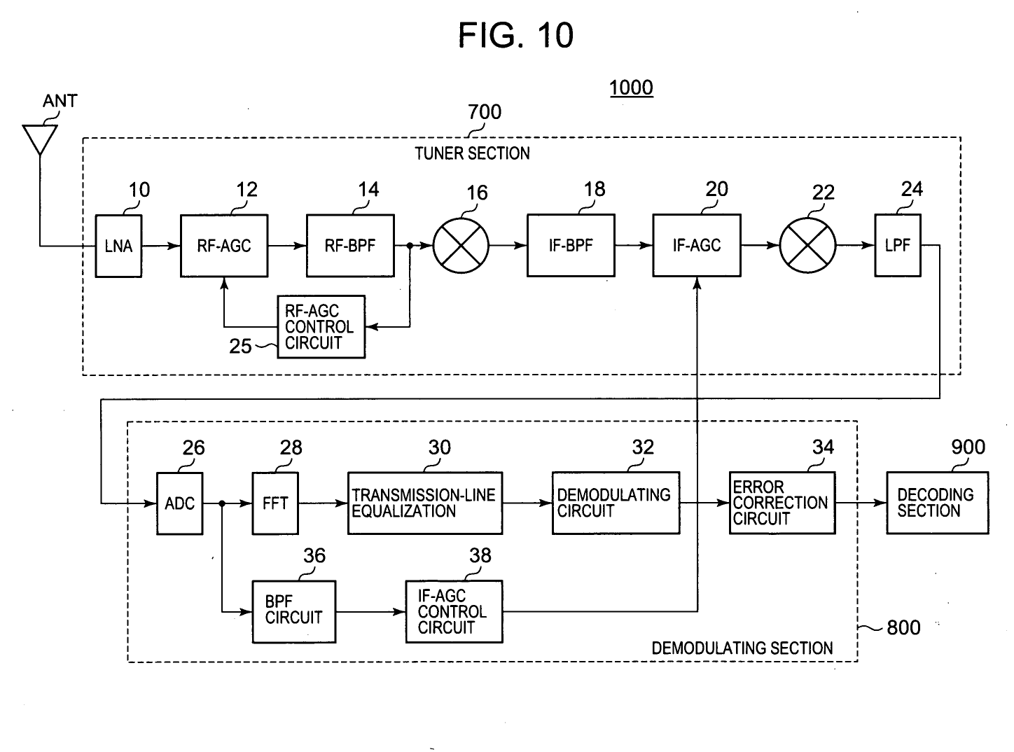

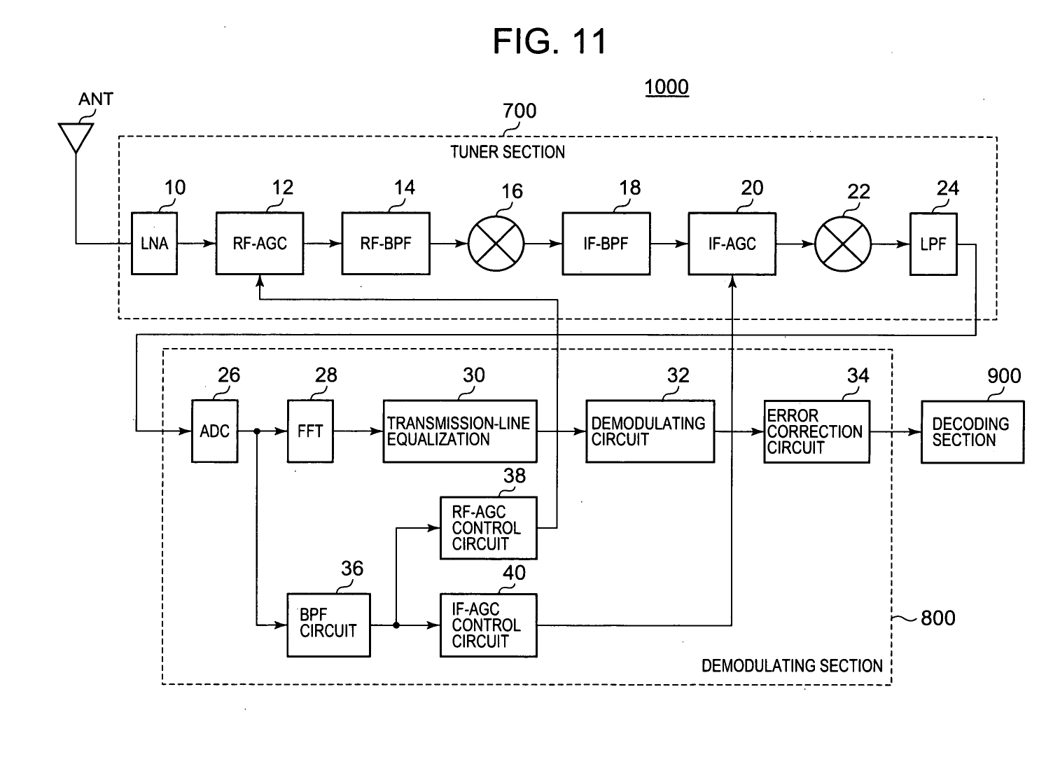

FIG. 9 is a block diagram showing a circuit configuration of OFDM signal receiving apparatus 600 according to the third embodiment of the invention. As shown in FIG. 9, OFDM signal receiving apparatus 600 of the third embodiment comprises a tuner section 100, demodulating section 200 and decoding section 300. The tuner section 100 and decoding section 300 have the same circuit configurations as those of the first embodiment. The demodulating section 200 has a substantially similar circuit configuration to that of the first embodiment. Therefore, only different circuit configuration of the third embodiment from the first embodiment will be described, and further description of the same circuit configuration of the third embodiment as the first embodiment will be omitted.

Data signals and SP signals included in OFDM signal output from FFT circuit 202 in the decoding section 200 are input to the average-value calculating circuit 212, wherein an average value of levels of the data signals and SP signals are calculated. DAC circuit 213 converts the average value calculated by the average-value calculating circuit 212 into an analog signal. The analog signal is fed back to IF-AGC circuit 107 to control the gain thereof. Therefore, even though a noise of a high level should be included in the data signals and SP signals of OFDM signal, the effect of the noise given to the control signal is minimized because the levels of OFDM signal of one symbol or more symbols are averaged to generate the control signal.

As described above, OFDM signal receiving apparatus according to the third embodiment of the invention comprises RF-AGC circuit 102, IF-AGC circuit 107, FFT circuit 202, average-value calculating circuit 212, and DAC circuit 213. RF-AGC circuit 102 amplifies the high frequency OFDM signal obtained from the received OFDM modulated electro-magnetic wave. IF-AGC circuit 107 amplifies the intermediate frequency OFDM signal which is obtained by frequency-converting OFDM signal amplified by RF-AGC circuit 102. FFT circuit 202 executes Fast Fourier Transform process on OFDM signal amplified by IF-AGC circuit 107 to transform the same signal from a time region to a frequency region. The average-value calculating circuit 212 calculates the average of levels of OFDM signal transformed to the frequency region by FFT circuit 202. DAC circuit 213 generates a control signal based on the average value calculated by the average-value calculating circuit 212, and supplies the same control signal to IF-AGC circuit 107, thereby controlling the gain of IF-AGC circuit 107.

Therefore, even though the received electro-magnetic wave should include a noise of large amplitude, a control signal is generated based on the average value of level of OFDM signal of 432 carriers in each symbol, thereby the noise effect is minimized, and the gain of IF-AGC circuit 107 is appropriately controlled by the control signal.

In each embodiment of OFDM signal receiving apparatus, the control signal is generated based on the average value calculated by the average-value calculating circuit 212, and the generated control signal is fed back to IF-AGC circuit 107 to control the gain thereof. But modification may be made to OFDM signal receiving apparatus, such that a control signal is generated based on the average value calculated by the average-value calculating circuit 212 and that the generated control signal is fed back not to IF-AGC circuit 107 but to RF-AGC circuit 102 to control the gain thereof.

Further, another modification may be made such that the control signal generated based on the average value calculated by the average-value calculating circuit 212 is supplied both to the RF-AGC circuit 102 for amplifying a high frequency signal and the IF-AGC circuit 107 for amplifying an intermediate signal.

In this case, even though the received electro-magnetic wave should include a noise of large amplitude, a control signal is generated based on the average value of the level of OFDM signal and the gain of RF-AGC circuit 102 is controlled based on such control signal, thereby not only the gain of an intermediate frequency OFDM signal but also the gain of a high frequency OFDM signal are appropriately controlled.

In the first and second embodiment of OFDM signal receiving apparatus, the control signal for controlling the gain of IF-AGC circuit 107 is generated based on the SP signals extracted from OFDM signal, but the control signal may be generated based on the extracted synchronizing signals in place of SP signals. In the digitalized terrestrial broadcast, data signal which includes not only content data signal but also synchronizing signals for discriminating various sorts of information is transmitted and such synchronizing signals are used to discriminate information at a data receiving site. Therefore, a modification may be made such that synchronizing signals other than SP signals may be used to generate such control signal.

What is claimed is:

1. An OFDM signal receiving apparatus comprising:
receiving means for receiving OFDM modulated electro-magnetic wave to obtain a high frequency OFDM signal;
high frequency amplifying means for amplifying the high frequency OFDM signal obtained by the receiving means;
frequency converting means for converting the high frequency OFDM signal amplified by the high frequency amplifying means into an intermediate frequency OFDM signal;
intermediate frequency amplifying means for amplifying the intermediate frequency OFDM signal obtained by the frequency converting means;
extracting means for extracting synchronizing signals regularly disposed in the intermediate frequency OFDM signal amplified by the intermediate frequency amplifying means;
calculating means for calculating an average value of amplitudes of the predetermined number of synchronizing signals extracted by the extracting means; and
control signal generating means for generating a control signal for controlling gain of at least one of the high frequency amplifying means and intermediate frequency amplifying means, based on the average value calculated by the calculating means.

2. The OFDM signal receiving apparatus according to claim 1, wherein the calculating means calculates an average value of amplitudes of the predetermined number of synchronizing signals excluding the first highest amplitude to n-th highest amplitude of synchronizing signals extracted by the extracting means, where “n” is an integer equivalent to or larger than “1”.

3. The OFDM signal receiving apparatus according to claim 1, wherein the extracting means extracts scattered pilot signals regularly disposed in the received OFDM signal.

4. An OFDM signal receiving apparatus comprising:
receiving means for receiving OFDM modulated electro-magnetic wave to obtain a high frequency OFDM signal;
high frequency amplifying means for amplifying the high frequency OFDM signal obtained by the receiving means;
frequency converting means for converting the high frequency OFDM signal amplified by the high frequency amplifying means into an intermediate frequency OFDM signal;
intermediate frequency amplifying means for amplifying the intermediate frequency OFDM signal obtained by the frequency converting means;
transforming means for executing Fast Fourier Transform process on the intermediate frequency OFDM signal amplified by the intermediate frequency amplifying means to transform the OFDM signal from the time region to the frequency region;
calculating means for calculating an average value of an amplitude of OFDM signal transformed to the frequency region by the transforming means; and
control signal generating means for generating a control signal for controlling gain of at least one of the high frequency amplifying means and intermediate frequency amplifying means, based on the average value calculated by the calculating means.

5. A method of receiving OFDM signal, comprising:
step A of receiving OFDM modulated electro-magnetic wave to obtain a high frequency OFDM signal, and amplifying the obtained high frequency OFDM signal by high frequency amplifying means;
step B of converting the high frequency OFDM signal amplified in step A into an intermediate frequency OFDM signal, and amplifying the intermediate frequency OFDM signal by intermediate frequency amplifying means;
step C of extracting synchronizing signals regularly disposed in the intermediate frequency OFDM signal amplified in step B;
step D of calculating an average value of amplitudes of the predetermined number of synchronizing signals extracted in step C; and
step E of generating a control signal for controlling gain of at least one of the high frequency amplifying means and intermediate frequency amplifying means, based on the average value calculated in step D.

6. The method of receiving OFDM signal according to claim 5, wherein in step D is calculated an average value of amplitudes of the predetermined number of synchronizing signals excluding the first highest amplitude to n-th highest amplitude of synchronizing signals extracted in step C, where “n” is an integer equivalent to or larger than “1”.

7. The method of receiving OFDM signal according to claim 5, wherein in step C are extracted scattered pilot signals regularly disposed in the received OFDM signal.

8. A method of receiving OFDM signal, comprising:
step A of receiving OFDM modulated electro-magnetic wave to obtain a high frequency OFDM signal, and amplifying the high frequency OFDM signal by high frequency amplifying means;
step B of converting the high frequency OFDM signal amplified in step A into an intermediate frequency OFDM signal, and amplifying the intermediate frequency OFDM signal by intermediate frequency amplifying means;
step C of executing Fast Fourier Transform process on the intermediate frequency OFDM signal amplified in step B to transform the OFDM signal from the time region to the frequency region;
step D of calculating an average value of an amplitude of OFDM signal transformed to the frequency region in step C; and
step E of generating a control signal for controlling gain of at least one of the high frequency amplifying means and intermediate frequency amplifying means, based on the average value calculated in step D.

9. A digitalized terrestrial broadcast receiving apparatus comprising:
receiving means for receiving a digitalized terrestrial broadcast electro-magnetic wave to obtain a high frequency signal;
high frequency amplifying means for amplifying the high frequency signal obtained by the receiving means;
frequency converting means for converting the high frequency signal amplified by the high frequency amplifying means into an intermediate frequency signal;
intermediate frequency amplifying means for amplifying the intermediate frequency signal obtained by the frequency converting means;
extracting means for extracting scattered pilot signals regularly disposed in the intermediate frequency signal amplified by the intermediate frequency amplifying means;
calculating means for calculating an average value of amplitudes of the predetermined number of scattered pilot signals extracted by the extracting means; and
control signal generating means for generating a control signal for controlling gain of at least one of the high frequency amplifying means and intermediate frequency amplifying means, based on the average value calculated by the calculating means.

10. The digitalized terrestrial broadcast receiving apparatus according to claim 9, wherein the calculating means calculates an average value of amplitudes of the predetermined number of scattered pilot signals excluding the first highest amplitude to n-th highest amplitude of scattered pilot signals extracted by the extracting means, where “n” is an integer equivalent to or larger than “1”.

11. A digitalized terrestrial broadcast receiving apparatus comprising:
receiving means for receiving a digitalized terrestrial broadcast electro-magnetic wave to obtain a high frequency signal;
high frequency amplifying means for amplifying the high frequency signal obtained by the receiving means;
frequency converting means for converting the high frequency signal amplified by the high frequency amplifying means into an intermediate frequency signal;
intermediate frequency amplifying means for amplifying the intermediate frequency signal obtained by the frequency converting means;
transforming means for executing Fast Fourier Transform process on the intermediate frequency signal amplified by the intermediate frequency amplifying means to transform the signal from the time region to the frequency region;
calculating means for calculating an average value of an amplitude of signal transformed to the frequency region by the transforming means; and
control signal generating means for generating a control signal for controlling gain of at least one of the high frequency amplifying means and intermediate frequency amplifying means, based on the average value calculated by the calculating means.
